(19) United States
(12) Patent Application Publication
(10) Pub. No.: US 2006/0136899 A1
(43) Pub. Date: Jun. 22, 2006

(54) Method for programming/updating software using USB OTG

(75) Inventor: Sang-Hun Yoo, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/301,169

(22) Filed: Dec. 12, 2005

(30) Foreign Application Priority Data
Dec. 20, 2004 (KR) 108745/2004

(51) Int. Cl. G06F 9/44

(52) U.S. Cl. 717/168

(57) ABSTRACT

A method for programming/updating software using a USB (Universal Serial Bus) OTG (On-the-Go) is disclosed. The method includes a connection step of two devices each having a flash memory that carries a coding block performing a USB OTG connection that follows a serial interface standard, an operation mode determining step of one of the two connected devices operating as a host device according to the USB OTG standard while the other thereof operating as a target device, and a programming/updating step of the host device downloading the coding block of a newest version to the target device and the target device performing the programming/updating by the downloaded coding block of the newest version.

### PRIORITY

This application claims priority to an application entitled “Method for Programming/updating Software Using USB OTG” filed in the Korean Industrial Property Office on Dec. 20, 2004 and assigned Serial No. 2004-108745, the contents of which are hereby incorporated by reference.

### BACKGROUND OF THE INVENTION

1. Field of the Invention

The present invention relates to a method for programming/updating software of a plurality of devices even without requiring a host PC, and more particularly to a method for programming/updating software of a plurality of devices by making the respective devices operate as hosts and devices using a USB (Universal Serial Bus) OTG (On-The-Go) standard.

2. Description of the Related Art

Recently, the development cycle of embedded systems has become very short. Accordingly, it may be necessary or desirable to frequently perform a programming/burning or upgrading of software (i.e., firmware including bootloader, OS (Operating System) and data) in a flash memory installed inside a device by a user to update the software.

A conventional system for programming or updating software, as illustrated in FIG. 1, performs a simultaneous programming/updating of one or more devices 160, 162, 164, 166, 168, 170 and 172 using a host Personal Computer (PC) 100 and a USB hub 150. Specifically, a downloader 102 should be installed on the host PC side 100 as an application, and a coding block 104 to be copied into flash memories (not shown) of target devices should also be prepared on the host PC side 100. One or more target devices 160, 162, 164, 166, 168, 170 and 172 may be provided with bootloaders that communicate with the downloader 102 of the host PC 100 to download the coding block 104. The downloaded coding block is written in the flash memories of the target devices 160, 162, 164, 166, 168, 170 and 172 to effect the updating. Specifically, in a state that the target devices 160, 162, 164, 168, 170 and 172 in the circuit of FIG. 1 are recognized as USB peripheral devices, the downloader 102 of the host PC 100 transmits a command message and the coding block 104 to the respective target devices. However, the USB device has the limitations in that it can be used only through a PC. This is because the PC serves as a host with respect to an interface called the USB, and thus the USB is fully PC-dependent. The USB system can basically include one host PC and many peripheral devices.

The downloading method using the USB of the host PC as described above has the following problems. First, the downloading method always requires the host PC 100 in order to perform the programming or updating, and the application called the download 102 should be installed in the host PC. Second, a separate USB hub 150 is required in the case of programming/updating the software installed in a plurality of target devices. Accordingly, an ordinary user must install a specified program in his/her own computer in order to achieve the function of the host PC or must visit a service center for the upgrade of the program, which can be inconvenient. Moreover, software developers also require the host PC in order to test and install the software. Additionally, existing downloading methods require a great deal of time for updating and/or programming a large number of devices due to the limitations of the number of devices subject to programming.

Second, the number of devices that can be connected through the USB hub 150 is limited. That is, although the coding block can simultaneously be written in many target devices for the programming/updating of the program as illustrated in FIG. 1, the number of devices that can be connected through the USB hub is actually limited. Specifically, since only one USB line is provided between the host PC 100 and the USB hub 150, the corresponding line is used by the respective target devices in a time-division manner, and thus it takes a longer time period for transmitting an image through the hub as the number of target devices connected becomes larger. Consequently, although it is possible to simultaneously write the coding block in the flash memories of the several target devices, the whole processing speed is not greatly improved.

### SUMMARY OF THE INVENTION

Accordingly, the present invention has been designed to solve the above and other problems occurring in the prior art, and an object of the present invention is to provide a scheme for performing a programming/updating of software among devices even without a host PC.

Another object of the present invention is to provide a scheme for connection among a plurality of devices according to the USB OTG standard so as to improve the programming/updating time for the devices.

In order to accomplish the above and other objects, there is provided a method for programming/updating software using a USB OTG standard, according to the present invention, including a connection step of two devices each having a flash memory that carries a coding block performing a USB OTG connection that follows a serial interface standard, an operation mode determining step of one of the two connected devices operating as a host device according to the USB OTG standard while the other thereof operating as a target device, and a programming/updating step of the host device downloading the coding block of a newest version to the target device and the target device performing the programming/updating by the downloaded coding block of the newest version.

### BRIEF DESCRIPTION OF THE DRAWINGS

The above and other objects, features and advantages of the present invention will be more apparent from the following detailed description taken in conjunction with the accompanying drawings, in which:

FIG. 1 is a view explaining a conventional programming/updating method using a host PC and a USB hub;

FIGS. 2A and 2B are block diagrams illustrating the connection state of devices that function as a host and a target according to the present invention;

FIG. 3 is a block diagram illustrating inner constituent blocks of a host device and a target device according to the present invention;

FIG. 4A is a diagram illustrating an inner coding block of a host flash memory according to the present invention;

FIG. 4B is a diagram illustrating an inner coding block of a target flash memory according to the present invention;

FIG. 5 is a flow diagram illustrating a process of downloading a program of the newest version from a host device to a target device according to the present invention;

FIG. 6 is a diagram illustrating a cable connection state of a USB OTG according to the present invention; and

FIGS. 7A and 7B are exemplary views illustrating displays for inquiring whether to download according to the present invention.

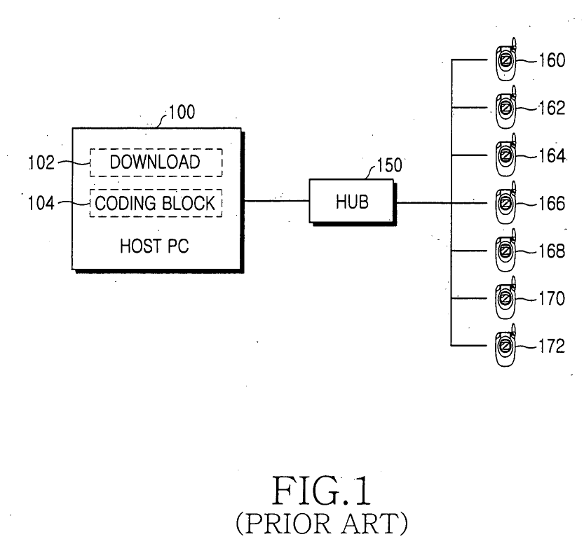

### DETAILED DESCRIPTION OF THE PREFERRED EMBODIMENTS

Preferred embodiments of the present invention will be described in detail hereinafter with reference to the accompanying drawings. In the following description of the present invention, the same drawing reference numerals are used for the same elements even in different drawings. Although a number of specific features, such as an element, the number of pixels, a specified numeric key, etc., are given below, they are presented for a better understanding of the present invention only. Also, it will be clear to those skilled in the art that the present invention can easily be practiced without such specific features or through their modifications. Additionally, a detailed description of known functions and configurations incorporated herein will be omitted when it may obscure the subject matter of the present invention.

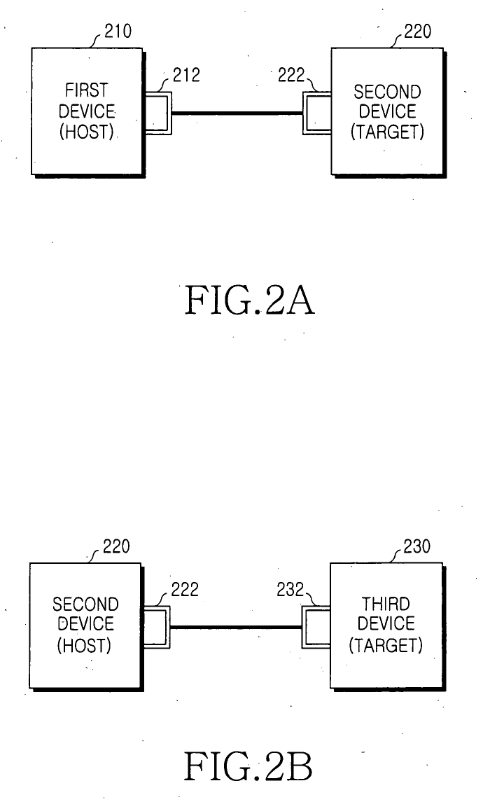

FIGS. 2A and 2B are block diagrams illustrating the connection state of devices that function as a host and a target according to the present invention. The first device 210, the second device 220 and the third device 230 are electronic appliances (for example, and electronic terminal such as a mobile phone, an MP3 player, a printer, a digital camera, etc.) of the same kind that have the same hardware and software so as to perform the same operation, and the devices are provided with USB OTG standard ports 212, 222 and 232, respectively. The USB OTG standard is a serial communication specification newly standardized in 2001, and is typically known as an extension or a modified standard of USB (1.1 and 2.0). The USB OTG is an independent USB interface that does not leave the role of a host to the PC but enables USB devices themselves to connect with one another to send/receive data with one another. Specifically, the USB OTG chip having a self-hosting function is mounted on a USB interface, and thus it is possible to perform an “any-to-any” type data transmission such as the transmission of a digital photograph from a digital camera (not shown) to a printer (not shown) directly connected to the digital camera, listening to an MP3 music through a home audio appliance (e.g., a refrigerator), which is directly connected to a users mobile phone etc. In other words, the USB is a new interface among digital appliances that makes it possible to escape from a PC-centered master-slave structure and greatly improves the utility of diverse devices such as a PDA, a mobile phone, an MP3 player, etc. The USB OTG is standardized by the Institute for Electrical and Electronics Engineers (IEEE) 1394 standard that defines a “peer-to-peer (P2P)” structure and makes the data transmission among the digital appliances (i.e., devices) possible even without the PC. The communication speeds defined by the IEEE 1394 standard are 100 Mbps, 200 Mbps and 400 Mbps. Moreover, speeds of up to 800 Mbps or 1600 Mbps are envisioned.

Accordingly, the first device 210, the second device 220 and the third device 230 provided with the USB OTG ports according to the IEEE 1394 standard as described above may operate as either a host or a target in performing the programming or updating. For example, in the case in which the first device 210 operates as a host and the second device 220 operates as a target as illustrated in FIG. 2A, in which the first device 210 serves as the host and downloads a program of the new version stored in the first device's 210 flash memory (not shown) to the second device 220 that serves as the target, and thus the second device 220 can write the downloaded program in its own flash memory to perform the updating.

Meanwhile, in the case in which the second device 220 completes the programming or updating as the target device and has the new program as described above, the second device 220 can operate as the host device 220, not as the target device, as illustrated in FIG. 2B, and transmit the downloaded program of the newest version to the third device 230. As a result, the respective device can operate as either the host or as the target according to the USB OTG standard, so that a device can transmit the program of the newest version as the host device or download the program of the newest version as the target device. In the above description, the program means a coding block of a machine code having an algorithm that operates in the device. Hereinafter, for the convenience in explanation, although an object being downloaded and updated is limited to a program, it will be apparent that the object may be diverse coding blocks such as operation data, a bootloader, a downloader, etc., in addition to the program.

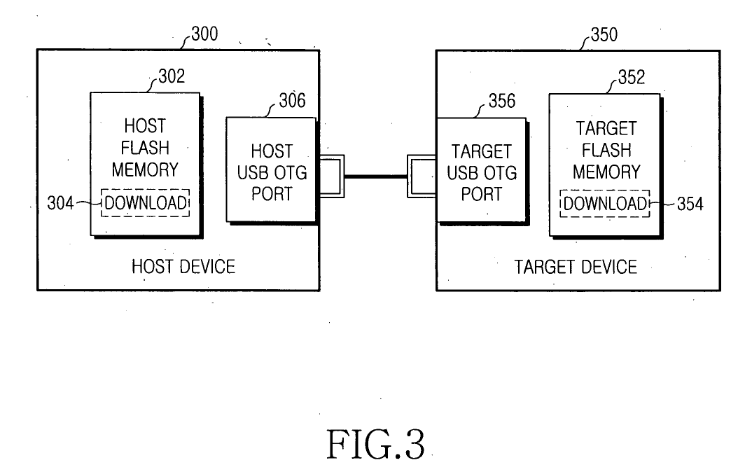

FIG. 3 is a block diagram illustrating inner constituent blocks of a host device and a target device according to the present invention.

The host device 300 is a device having a program of the newest version, and performs functions corresponding to a host PC in comparison to a USB interface. The host device 300 is provided with a host flash memory 302 and a host USB OTG port 306. The host flash memory 302 is a non-volatile memory in which an updated program of the newest version is stored, and thus the host device 300 can transmit the program of the newest version to the target device 350. A downloader 304 that is a module provided in the host flash memory takes charge of such transmission. The host USB OTG port 306 is a USB OTG port that satisfies the above-described IEEE 1394 standard, and operates as a host during a USB OTG interfacing. In the same manner, a target flash memory 352 in the target device 350 is a non-volatile memory in which a program of an old version is stored, and a target USB OTG port 356 is a port that operates as a target during the USB OTG interfacing. A bootloader 354 takes charge of booting of the target flash memory, and a download function is implemented in the bootloader.

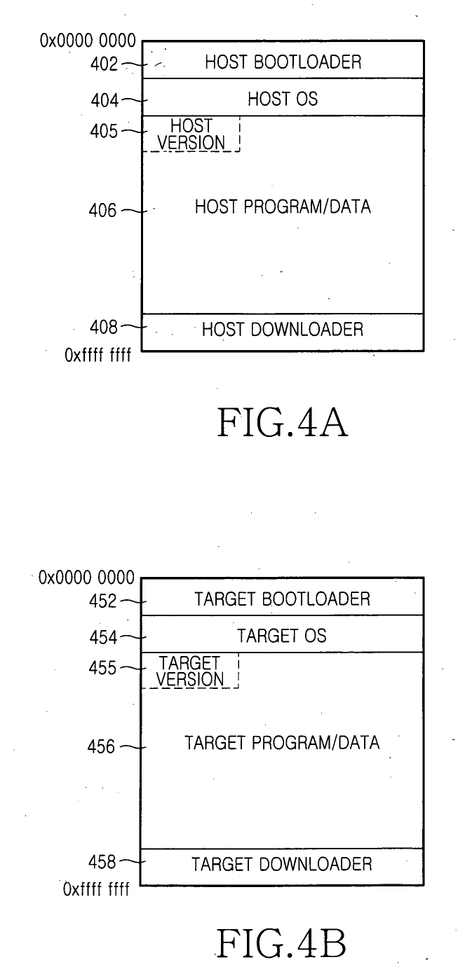

Meanwhile, the host flash memory 302 and the target flash memory 352 are the non-volatile memory having the same inner block construction, but the difference between them is that the host flash memory 302 stores the program of the newest version but the target flash memory 352 stores the program of the old version. Hereinafter, the inner coding blocks of the flash memory (i.e., the host flash memory and the target flash memory) will be explained in detail with reference to FIGS. 4A and 4B.

Both the host flash memory and the target flash memory are provided with coding blocks of a bootloader, OS, program/data and downloader, and perform the same function. Hereinafter, the bootloader of the host flash memory is called a host bootloader 402, and the bootloader of the target flash memory is called a target bootloader 452. The OS, program/data and downloader are called in the same manner as the bootloader according to whether the corresponding coding block is the coding block in the host flash memory or in the target flash memory.

The host bootloader 402 and the target bootloader 452 are coding blocks that take charge of booting and driving of the device, and the host OS 404 and the target OS 454 are coding blocks of a system operating system such as an RTOS (Real Time Operating System). In particular, the target bootloader 452 has a download algorithm for performing the program of the newest version if it receives the download of the program of the newest version from the host device.

The host program/data 406 and the target program/data 456 are coding blocks that contain specified operation algorithms, operation data and user data. In particular, the respective programs have their own versions, and the host device and the target device can determine whether to download by confirming the version of the opposite party. For example, if it is confirmed that the host version 405 that is the version of the host program is the newest version and the target version 455 that is the version of the target program is the old version, the host program 406 of the newest version is downloaded to the target program region 456 of the target device.

The host downloader 408 is a coding block having a downloading algorithm that transmits the program of the newest version owned by the coding block itself to the target device when the device operates as the host device. Meanwhile, a downloader 458 is provided even in the target device that does not require the downloader function. This is because the target device may be used as the host device at a later time, and if so, the downloader 458 would be required in order to perform the downloader function.

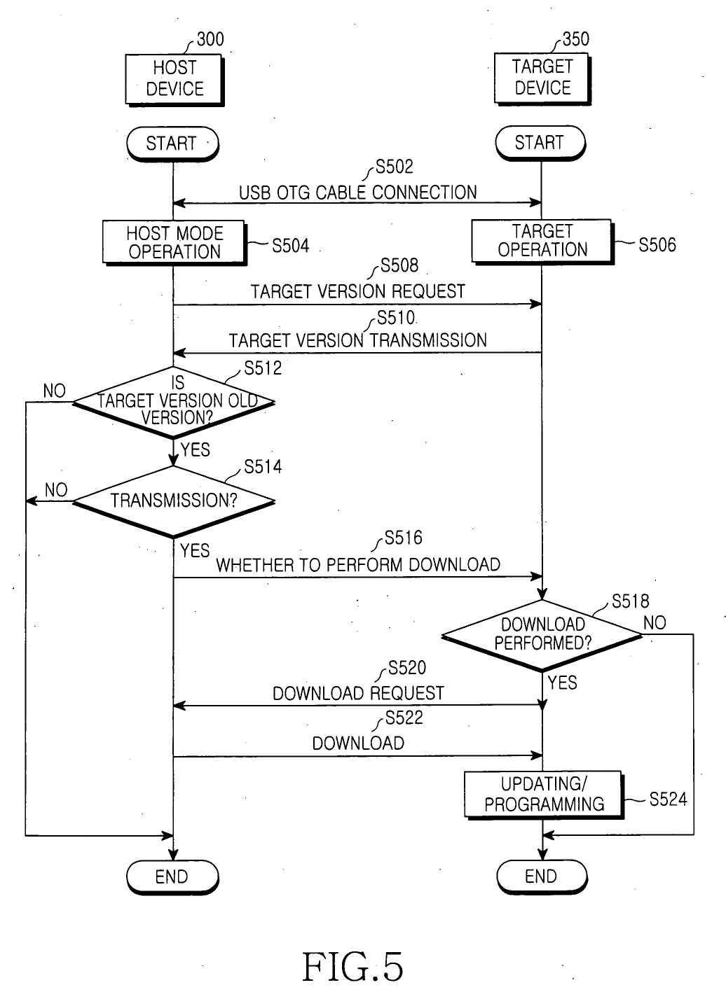

FIG. 5 is a flow diagram illustrating a process of downloading a program of the newest version from a host device to a target device according to the present invention.

If a USB cable is connected to USB OTG ports of both the host device 300 and the target device 350 (step S502) and the USB OTG interface is performed, one of the two devices operates in a host mode (step S504) and the other thereof operates in a target mode (step S506). When the USB cable is connected as described above, it may be determined by hardware or software which device operates as the host device and which device operates as the target device.

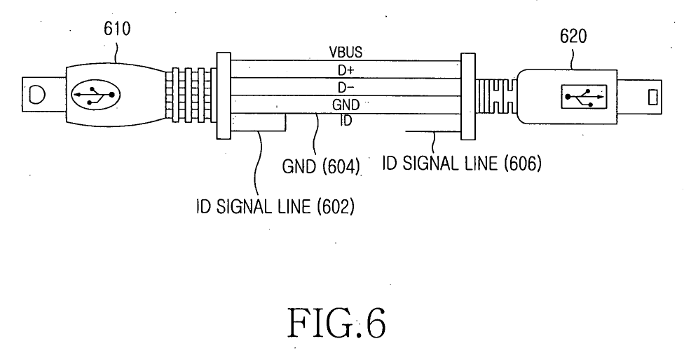

In the case of implementing the host and target devices by hardware, is illustrated in FIG. 6, wherein an ID signal line is disconnected between the two devices 610 and 620 thus forming two ID signal lines 602 and 606 corresponding to devices 610 and 620, respectively. Using this setup, if one of terminals of the ID signal line 602 of the USB cable is short-circuited to a ground (GND) signal line 604, a device connected to the corresponding terminal 610 operates as the host. Conversely, if the ID signal line 606 of the terminal is not short-circuited to the GND signal line 604 but is left open, a device connected to the corresponding terminal 620 operates as the target. Because this hardwired method has already been proposed in the USB OTG standard, a detailed explanation thereof will be omitted.

In the case of implementing the host and target devices by software, the host and the target are determined using an HNC (Host Negotiation Protocol) proposed in the USB OTG standard. At that time, the determination is made based on the software versions stored in the flash memories of both of the devices. The program versions in the flash memories of both devices are compared according to the protocol, and the device having the newest version operates as the host.

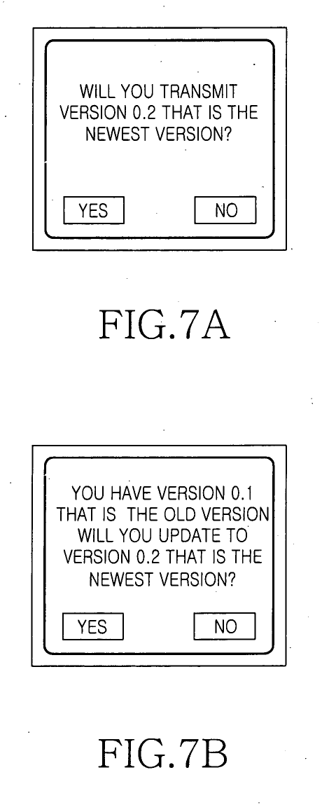

After the downloader of the host device 300 is determined using a hardware or software scheme as described above, the downloader of the host device 300 requests the target program version in the flash memory to the target device 350 (step S508). If the bootloader of the target device 350 that received the target program version transmission request transmits the target version (step S510), the downloader of the host device 350 determines whether the received target program version coincides with the host program version using the downloader itself (step S512). If the target program version is older than the host program version as a result of comparison, the downloader of the host device displays a message as illustrated in FIG. 7A on a host device 300 display window which inquires whether the host device should transmit the newest version of the target program (step S514). If the user selects the transmission of the newest version, the host device 300 transmits a message for inquiring of the target device whether to receive the download of the newest version together with the host version (step S516). The target device 300 displays the message as illustrated in FIG. 7B on a target device's display window which inquires whether to download the newest version of the target program (step S518). If the user selects the download execution, the target device 300 requests the download from the host device to receive the download of the corresponding program of the newest version (step S520). The download is then performed (step S522). The target device 350 then completes the program update by performing steps such as by writing the downloaded program of the newest version on a program region of its flash memory (step S524).

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for programming/updating software using a Universal Serial Bus (USB) On-The-Go OTG standard, comprising:
connecting two devices each having a flash memory which carries a coding block performing a USB OTG connection according to a serial interface standard;
determining an operating mode of the two connected devices with one of the two connected devices operating as a host device according to the USB OTG standard and the other thereof operating as a target device according to the USB OTG standard; and
downloading, for programming/updating by the host device, a coding block of a newest version to the target device; and
performing the programming/updating by the target device using the downloaded coding block of the newest version.

2. The method as claimed in claim 1, wherein the step of determining an operation mode comprises determining the host device and the target device in accordance with a connection state of an ID signal line and a ground line of a terminal according to the USB OTG standard.

3. The method as claimed in claim 1, wherein the step of determining the operation mode comprises determining the device having the newest version as the host device and the device having a version older that the newest version as the target device by confirming the versions of both coding blocks according to an HNC (Host Negotiation Protocol) protocol of the USB OTG standard.

4. The method as claimed in claim 1, wherein the step of downloading for programming/updating by the host device comprises requesting and receiving, by the host device, a version of the coding block in the flash memory of the target device from the target device, transmitting the host coding block of the corresponding host version to the target device, if the version (i.e., host version) of the coding block in the flash memory of the host device is newer than the target's versions; and
wherein the step of programming/updating by the target device comprises the target device performing a programming/updating using the downloaded host coding block.

5. The method as claimed in claim 1, wherein the steps of programming/updating by the target device and the host device comprises requesting an approval of the updating to the newest version from the user and performing the updating if the user approves the update.

6. The method as claimed in claim 5, wherein the step of requesting comprises displaying a request for approval on both a display screen of the host device and the target device.
